(19) United States
(12) Patent Application Publication
(10) Pub. No.: US 2025/0211684 A1
(43) Pub. Date: Jun. 26, 2025

(54) DYNAMIC TRAFFIC CLASSIFICATION AND HANDLING USING CHARGING COUNTERS

(71) Applicants: AT&T Intellectual Property I, L.P., Atlanta, GA (US); AT&T Mobility II LLC, Atlanta, GA (US)

(72) Inventors: Michael Cercena, Hockessin, DE (US); Jeffrey Young, Frisco, TX (US); Lea Berba, Sammamish, WA (US); Ling Sun, San Antonio, TX (US); Anoop Santh Mayor, Newcastle, WA (US); Karthikeyan Duraiswamy, Bothell, WA (US); Kiran Banoor, Frisco, TX (US)

(21) Appl. No.: 18/393,576

(22) Filed: Dec. 21, 2023

(51) Int. Cl. H04M 15/00; H04L 41/0894

(52) U.S. Cl. CPC H04M 15/66; H04L 41/0894

(57) ABSTRACT

A method performed by a processing system in a cellular core network includes receiving, from a session management function of the cellular core network, a query for a policy rule associated with a subscriber who has requested a packet data unit session, querying a charging function of the cellular core network for a charging counter associated with the subscriber, receiving, from the charging function, the charging counter, wherein the charging counter contains a value identifying a service package to which the subscriber is subscribed, determining a rating group associated with the service package, and sending, to the session management function, a set of application identifiers associated with the rating group, wherein each application identifier of the set of application identifiers identifies one software application that is included in the service package.

The present disclosure relates generally to wireless communications and relates more particularly to devices, non-transitory computer-readable media, and methods for dynamic traffic classification and handling using charging counters.

### BACKGROUND

Wireless networks allow users to access a variety of applications and services through a variety of devices. For instance, in addition to being able to access applications and services through mobile phones, tablets, gaming devices, and the like, users may also be able to access applications and services (such as satellite and streaming radio applications, navigation applications, roadside assistance services, and the like) through connected vehicles.

### SUMMARY

In one example, the present disclosure describes a device, computer-readable medium, and method for dynamic traffic classification and handling using charging counters. For instance, in one example, a method performed by a processing system in a cellular core network includes receiving, from a session management function of the cellular core network, a query for a policy rule associated with a subscriber who has requested a packet data unit session, querying a charging function of the cellular core network for a charging counter associated with the subscriber, receiving, from the charging function, the charging counter, wherein the charging counter contains a value identifying a service package to which the subscriber is subscribed, determining a rating group associated with the service package, and sending, to the session management function, a set of application identifiers associated with the rating group, wherein each application identifier of the set of application identifiers identifies one software application that is included in the service package.

In another example, a non-transitory computer-readable medium stores instructions which, when executed by a processor in a cellular core network, cause the processor to perform operations. The operations include receiving, from a session management function of the cellular core network, a query for a policy rule associated with a subscriber who has requested a packet data unit session, querying a charging function of the cellular core network for a charging counter associated with the subscriber, receiving, from the charging function, the charging counter, wherein the charging counter contains a value identifying a service package to which the subscriber is subscribed, determining a rating group associated with the service package, and sending, to the session management function, a set of application identifiers associated with the rating group, wherein each application identifier of the set of application identifiers identifies one software application that is included in the service package.

In another example, a device includes a processor in a cellular core network and a computer-readable medium storing instructions which, when executed by the processor, cause the processor to perform operations. The operations include receiving, from a session management function of the cellular core network, a query for a policy rule associated with a subscriber who has requested a packet data unit session, querying a charging function of the cellular core network for a charging counter associated with the subscriber, receiving, from the charging function, the charging counter, wherein the charging counter contains a value identifying a service package to which the subscriber is subscribed, determining a rating group associated with the service package, and sending, to the session management function, a set of application identifiers associated with the rating group, wherein each application identifier of the set of application identifiers identifies one software application that is included in the service package.

### BRIEF DESCRIPTION OF THE DRAWINGS

The teachings of the present disclosure can be readily understood by considering the following detailed description in conjunction with the accompanying drawings, in which:

FIG. 1 illustrates an example network, or system, in which examples of the present disclosure may operate;

FIG. 2 illustrates an example data network name definition that utilizes data access indicator values and rating group identifiers to apply dynamic policies for treatment of applications;

FIG. 3 illustrates a flowchart of an example method for dynamic traffic classification and handling using charging counters, in accordance with the present disclosure;

FIG. 4 illustrates a flowchart of an example method for dynamic traffic classification and handling using charging counters, in accordance with the present disclosure; and

FIG. 5 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure uses charging counters that map application detection methods to data network name (DNN) policies in order to provide dynamic traffic classification and handling. As discussed above, wireless networks allow users to access a variety of applications and services through a variety of devices. For instance, in addition to being able to access applications and services through mobile phones, tablets, gaming devices, and the like, users may also be able to access applications and services (such as satellite and streaming radio applications, navigation applications, roadside assistance services, and the like) through connected vehicles.

Examples of the present disclosure identify software applications that are accessed by a user endpoint device via a wireless network and apply dynamic policies to the software applications based on charging information that indicates how the software applications are to be treated for billing purposes. In one example, an operator of a cellular core network assigns charging counters to data network names (DNNs) associated with service packages (e.g., packages of applications and services that are billed as a single charge). The charging counters map the DNNs to application detection methods that are used to detect when packet flows to and from the user endpoint devices are destined for specific applications or services. The charging counters allow dynamic policy and treatment to be applied to packet flows using standard application detection methods. For instance, based on a particular application or service being detected in a packet flow associated with a user endpoint device, the user endpoint device may be permitted to connect to the particular application or service, blocked from connecting to the particular application or service, or redirected to a portal or landing page via which a subscriber using the user endpoint device may be presented with an offer to subscribe to the particular application or service.

Thus, examples of the present disclosure allow appropriate action to be taken in response to wireless data usage based on a charging profile for a user endpoint device. Additionally, applications and services can be grouped together and offered to subscribers as packages associated with different charging values, and the network can efficiently allow and rate data usage by user endpoint devices, drop usage by the user endpoint devices, or redirect the user endpoint devices. Applications and services can be grouped together and associated with a rating group that supports different policy decisions with the network. This reduces the time to market for packages of diverse applications and services.

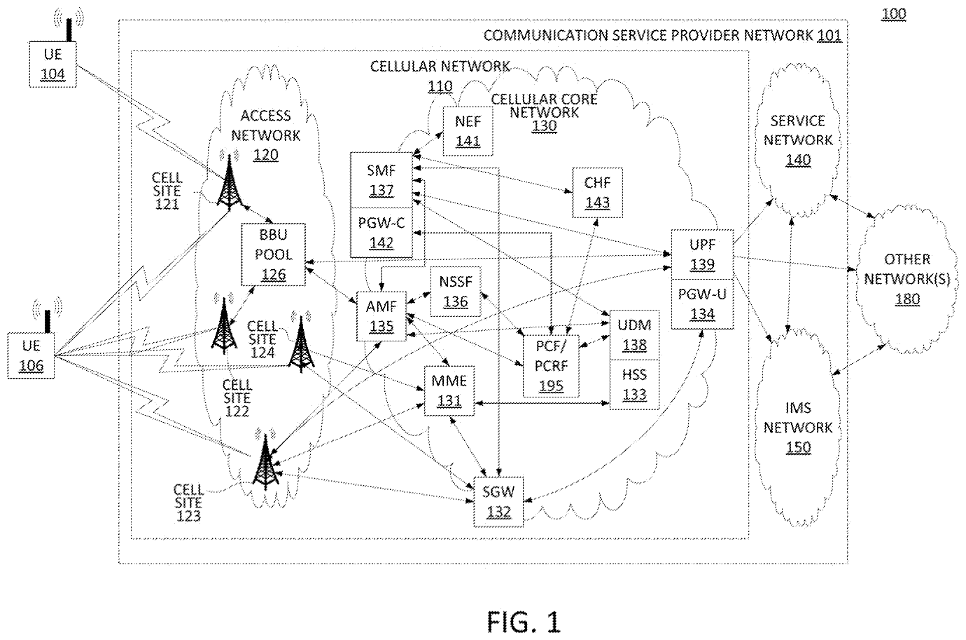

Although examples of the present disclosure are discussed below within the context of fifth generation (5G) cellular networks, the examples disclosed herein are equally applicable to previous generation (e.g., 3G and 4G) networks as well as next-generation (e.g., 6G and beyond 5G) networks, as well as networks that combine elements of 5G networks with elements of previous and/or next-generation networks. For instance, as 5G deployment progresses, many networks currently in operation may not be fully 5G, but may be hybrids of previous generation (e.g., 3G and/or 4G) and 5G. Thus terminology used herein that is specific to 5G, such as packet data unit or data network name, may be understood to broadly encompass equivalents in previous and/or next-generation networks (such as packet data network or access point name). These and other aspects of the present disclosure are discussed in greater detail in connection with FIGS. 1-5, below.

FIG. 1 illustrates an example network, or system, 100 in which examples of the present disclosure may operate. In one example, the system 100 includes a communication service provider network 101. The communication service provider network 101 may comprise a cellular network 110 (e.g., a 5G network, a 4G/Long Term Evolution (LTE)/5G hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network 130. In one example, the access network 120 may comprise a radio access network (RAN), such as a cloud RAN, a distributed RAN (D-RAN), a centralized RAN (C-RAN), a virtualized RAN (V-RAN), or an open RAN (O-RAN). In one example, access network 120 may include cell sites 121 and 122 and a baseband unit (BBU) pool 126. In a cloud RAN, radio frequency (RF) components, referred to as remote radio heads (RRHs) or radio units (RUs), may be deployed remotely from baseband units, e.g., atop cell site masts, buildings, and so forth. In one example, the BBU pool 126 may be located at distances as far as 20-80 kilometers or more away from the antennas/remote radio heads of cell sites 121 and 122 that are serviced by the BBU pool 126. It should also be noted in accordance with efforts to migrate to 5G networks, cell sites may be deployed with new antenna and radio infrastructures such as MIMO antennas, and millimeter wave antennas.

Although cloud RAN infrastructure may include distributed RRHs and centralized baseband units, a heterogeneous network may include cell sites where RRH and BBU components remain co-located at the cell site. For instance, cell site 123 may include RRH and BBU components. Thus, cell site 123 may comprise a self-contained “base station.” With regard to cell sites 121 and 122, the “base stations” may comprise RRHs at cell sites 121 and 122 coupled with respective baseband units of BBU pool 126. In one example, baseband unit functionality may be split into a centralized unit (CU) and a distributed unit (DU). In addition, the CU and the DU may be physically separate from one another. For instance, a DU may be situated with an RU/RRH at a cell site, while a CU may be in a centralized location hosting multiple CUs. Alternatively, or in addition, a single CU may serve multiple DUs and/or RUs/RRHs. In accordance with the present disclosure a “base station” may therefore comprise at least a BBU (e.g., in one example, a CU and/or a DU), and may further include at least one RRH/RU.

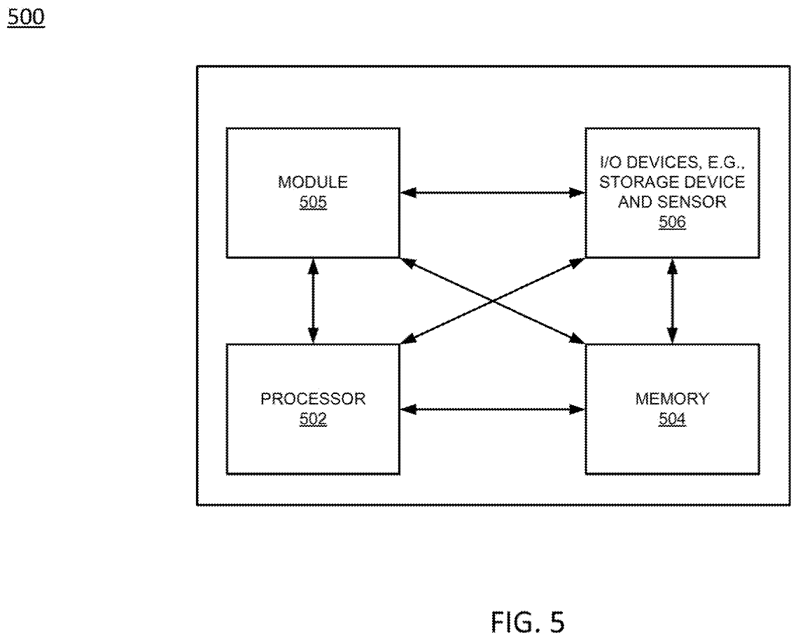

In one example, any one or more of cell sites 121-124 may be deployed with antenna and radio infrastructures, including MIMO and millimeter wave antennas. In further examples, a base station (e.g., cell sites 121-124 and/or baseband units within BBU pool 126) may comprise all or a portion of a computing system, such as computing system 500 as depicted in FIG. 5, and may be configured to perform steps, functions, and/or operations in connection with examples of the present disclosure for dynamic traffic classification and handling using charging counters.

In one example, access network 120 may include both 4G/LTE and 5G/NR radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126.

In cellular core network 130, network nodes such as Mobility Management Entity (MME) 131 and Serving Gateway (SGW) 132 support various functions as part of the cellular network 110. For example, MME 131 is the control node for LTE access network components, e.g., eNodeB aspects of cell sites 121-123. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway user plane function (PGW-U) 134 and a PGW control plane function (PGW-C) 142 which serve as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 5G network components, 3G network components, etc. Thus, cellular core network 130 may comprise an integrated network, e.g., including any two or more of 2G-5G infrastructures and technologies (or any future infrastructures and technologies to be deployed, e.g., 6G), and the like. For example, as illustrated in FIG. 1, cellular core network 130 further comprises 5G components, including: an access and mobility management function (AMF) 135, a network slice selection function (NSSF) 136, a session management function (SMF) 137, a unified data management function (UDM) 138, and a user plane function (UPF) 139.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, such as AMF(s), SMF(s), UPF(s), and so forth that may be arranged into different network slices which may logically be considered to be separate cellular networks. In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, and so forth.

In one example, SMF 137 may perform endpoint device IP address management, UPF selection, UPF configuration for endpoint device traffic routing to an external packet data network (PDN), charging data collection, quality of service (QOS) enforcement, and so forth. UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

In accordance with examples of the present disclosure, the core network 130 may additionally include a network exposure function (NEF) 141, a policy control function/policy and charging rules function (PCF/PCRF) 195, and a charging function (CHF) 143. The NEF 141 may securely expose capabilities of the core network 130 and events provided by network functions to application functions. In one example, the NEF may map application functions to packet flow descriptors (PFDs) that describe how network packets associated with the application functions are to be processed, forwarded, and modified as they traverse the communication service provider network 101.

In one example, the PCF/PCRF 195 may support policy control decisions and charging control functionalities based on packet flows. For instance, the PCF/PCRF 195 may provide policies and rules for control plane functions such as detecting application and service packet flows, gating, QoS, and packet flow-based charging to the SMF 137. To support packet flow-based charging decisions, the PCF/PCRF 195 may access subscription information stored in the UDM 138. Within the context of the present disclosure, charging refers to the function for collecting subscriber usage records, rating the usage records, and charging subscribers for the usage in real time. Thus, packet flow-based charging decisions made by the PCF/PCRF 195 may ensure the reliable monitoring of applications, services, and use cases and the associated monetary charges to subscribers.

In one example, the CHF 143 provides functions including a subscriber account balance management function, a rating function, and a charging gateway function. Thus, the CHF 143 supports real time billing and application and service monetization, subscriber management and provisioning, integration with third-party application programming interfaces (APIs), and other functions. This allows an operator of the communication service provider network to charge subscribers based on the applications and services delivered to the subscribers, as opposed to charging a single flat rate to all subscribers. In one example, the CHF 143 may maintain subscriber charging counters which may be provided to the PCF/PCRF 195 for use in applying policies.

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., a “5GC”). For instance, in non-standalone (NSA) mode architecture, LTE radio equipment may continue to be used for cell signaling and management communications, while user data may rely upon a 5G new radio (NR), including millimeter wave communications, for example. However, examples of the present disclosure may also relate to a hybrid, or integrated 4G/LTE-5G cellular core network such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1. It should be noted that intermediate devices and links between MME 131, SGW 132, cell sites 121-124, PGW 134, AMF 135, NSSF 136, SMF 137, UDM 138, and/or UPF 139, and other components of system 100 are also omitted for clarity, such as additional routers, switches, gateways, and the like.

FIG. 1 also illustrates various endpoint devices, e.g., user equipment (UE) 104 and 106. Each of the UEs 104 and 106 may comprise a cellular telephone, a smartphone, a tablet computing device, a laptop computer, a pair of computing glasses, a wireless enabled wristwatch, a wireless transceiver for a fixed wireless broadband (FWB) deployment, an Internet of Things (IoT) device, a connected vehicle, or any other cellular-capable mobile telephony and computing device (broadly, “an endpoint device”). For instance, each of the UEs 104 and 106 may include one or more radio frequency (RF) transceivers for cellular communications and/or for non-cellular wireless communications. In one example, each of the UEs 104 and 106 may be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive and/or to transmit multi-path and/or spatial diversity signals.

In one example, each of the UEs 104 and 106 may comprise all or a portion of a computing system, such as computing system 500 depicted in FIG. 5, and may be configured to perform steps, functions, and/or operations in connection with examples of the present disclosure for dynamic traffic classification and handling using charging counters. In this regard, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 5 and discussed below) or multiple computing devices collectively configured to perform various steps, functions, and/or operations in accordance with the present disclosure.

As illustrated in FIG. 1, UE 104 may access wireless services via the cell site 121 (e.g., NR alone, where cell site 121 comprises a gNB), while UE 106 may access wireless services via any of the cell sites 121-124 located in the access network 120 (e.g., for NR non-dual connectivity, for LTE non-dual connectivity, for NR-NR DC, for LTE-LTE DC, for EN-DC, and/or for NE-DC). For instance, in one example, UE 106 may establish and maintain connections to the cellular core network 130 via one or multiple gNBs (e.g., cell sites 121 and 122 and/or cell sites 121 and 122 in conjunction with BBU pool 126 and/or various other components, such as a CU and/or a DU). In another example, UE 106 may establish and maintain connections to the cellular core network 130 via a gNB (e.g., cell site 122 and/or cell site 122 in conjunction with BBU pool 126) and an eNodeB (e.g., cell site 124), respectively. In addition, either the gNB or the eNodeB may comprise a PCell, and the other may comprise a SCell for carrier aggregation and/or dual connectivity. Similarly, UE 106 may communicate with any of the cell sites 121 and 122 using carrier aggregation (CA) (e.g., in accordance with a CA technique). Furthermore, either or both of NR/5G and or EPC (4G/LTE) core network components may manage the communications between UE 106 and the cellular network 110 via cell site 122 and cell site 124.

In one example, UE 106 may also utilize different antenna arrays for 4G/LTE and 5G/NR, respectively. For instance, 5G antenna arrays may be arranged for beamforming in a frequency band designated for 5G high data rate communications. For instance, the antenna array for 5G may be designed for operation in a frequency band between 1 GHz and 7.125 GHZ. In contrast, an antenna array for 4G may be designed for operation in a frequency band less than 5 GHZ, e.g., 500 MHz to 3 GHZ. In addition, in one example, the 4G antenna array (and/or the RF or baseband processing components associated therewith) may not be configured for and/or be capable of beamforming. Accordingly, in one example, UE 106 may turn off a 4G/LTE radio, and may activate a 5G radio to send a request to activate a 5G session to cell site 122 (e.g., when it is chosen to operate in a non-DC mode or an intra-RAT dual connectivity mode), or may maintain both radios in an active state for multi-radio (MR) dual connectivity (MR-DC).

According to examples of the present disclosure, a sales and service delivery interface may allow users of the communication service provider network 101 (hereinafter “subscribers′) to subscribe to applications and services which may be offered by third-parties (i.e., parties other than an operator of the communication service provider network 101). These applications and services may include, for example, streaming media applications, services offered via satellite such as satellite radio and navigation services, roadside assistance services, and other applications and services. These applications and services may be delivered to the subscribers' user endpoint devices (e.g., user endpoint devices 104 and 106) via the communication service provider network 101.

The third parties may charge the subscribers a fee for accessing these applications and services. For instance, the third parties may charge a monthly fee, a yearly fee, a per-use fee, or the like. A plurality of applications and services may also be offered for a single fee as a package.

An operator of the communication service provider network 101 may work with the third parties in order to identify applications to be detected for charging purposes. Identified applications may be grouped into categories associated with policy decisions such as “always allowed,” “allowed with subscription,” or the like. For instance, if the policy associated with an application is “always allowed,” then a user endpoint device attempting to access the application may always be permitted to access the application. However, if the policy associated with an application is “allowed with subscription,” then a user endpoint device attempting to access the application may only be permitted to access the application if the user endpoint device (or a subscribed associated with the user endpoint device) is subscribed to the application. Furthermore, if the policy associated with the application is “allowed with subscription,” then a further policy may be defined to either block or redirect the application (e.g., on a DNN basis) when a user endpoint device that is not subscribed to the application attempts to access the application.

In one example, the policies are used to define CHF 143 data access indicators (DAI) values, which may be provided per DNN, and to define rating group identifiers to be assigned to the applications. In one example, DAI values may include at least one of: “ALLOW” (e.g., all applications on the DNN are allowed), “SUBn” (e.g., all applications on the DNN that identified with a SUBn rating group identifier are allowed, when n may be any number equal to a number of subscription packages offered), “DENY” (e.g., all applications that are not always allowed are blocked by default), or “REDIRECT” (e.g., all applications that are not always allowed are redirected to a subscription portal or landing page). In a further example, rating group identifiers may include at least one of: “1000” (e.g., always allowed application) or “200n” (e.g., SUBn application). In one example, each application may be further associated with a service identifier. Utilizing the DAI values and rating group identifiers, a DNN may be built in which a dynamic policy is defined for application treatment.

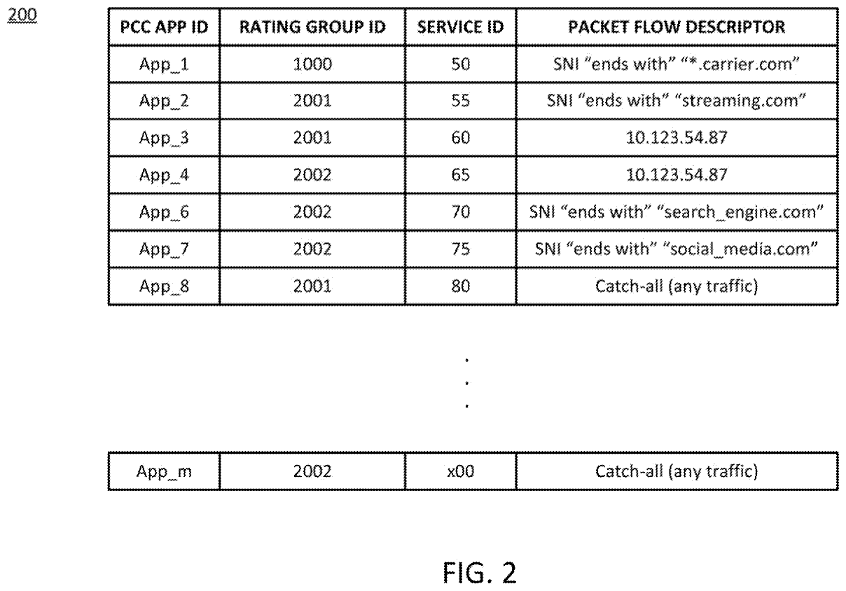

FIG. 2, for instance, illustrates an example data network name definition 200 that utilizes data access indicator values and rating group identifiers to apply dynamic policies for treatment of applications. In the example of FIG. 2, the entries for application identifiers (APP IDs) “App_8” and “App_m” are optionally defined to handle “catch-all” cases in the event that the applications do not match any packet flow descriptors.

When a subscriber subscribes to an application or service (or package of applications and services) offered by a third party, a profile associated with the subscriber in the UDM 138 may be updated to include information related to the subscription (such as a subscription tier to which the subscriber is subscribed, user endpoint devices that are permitted to access the application or service, the fee to be charged to the subscriber for the subscription, and/or the like). In addition, the CHF 143 may be updated to establish charging counters related to the application or service for the subscriber.

To access the application or service, the subscriber's user endpoint device (for the sake of example, user endpoint device 104 of FIG. 1) first needs to establish a packet data unit (PDU) session with the core network 130. The user endpoint device 104 may request that the AMF 135 establish this PDU session. The AMF 135 may query the UDM 138 to confirm that the user endpoint device 104 is associated with a user who is subscribed to the services of the communication service provider network 101. Once the AMF 135 has confirmed the user is a subscriber, the AMF 135 may forward the request to the SMF 137 for establishment of the PDU session.

As part of its operations to establish the PDU session, the SMF 137 may query the PCF/PCRF 195 for any policy rules for the PDU session, where the policy rules may define how the subscriber's data is to be treated (e.g., QoS, charging, and the like). The PCF/PCRF 195 may also query the CHF 143 for any session counters, including charging counters, that are associated with the subscriber. As discussed above, the charging counters may map application detection methods to DNN policies. The CHF 143 may also provide data access indicators (DAIs) that are defined by an operator of the cellular core network 130 and used to create an association with the profile of the subscriber for billing purposes. For instance, if the user endpoint device has been provisioned in the UDM with “SUB1” to indicate that the subscriber associated with the user endpoint device is subscribed to “Subscription Package 1,” then the CHF 134 may send a DAI counter to the PCF/PCRF 195 that includes the value “SUB1.”

The PCF/PCRF 195 provides the policies and charging counters to the SMF 137. For instance, continuing the example above in which the PCF/PCRF 195 has received, from the CHF 134, a DAI counter including the value “SUB1,” the PCF/PCRF 195 may send to the SMF the PCC APP IDs of the DNN definition 200 that match the rating group IDs of “1000” (e.g., always allowed application) and “2001” (SUB1 application).

The SMF 137 will cooperate with the UPF 139 to establish the user plane resources that are necessary to support the PDU session. For instance, the SMF 137 may maintain context for the PDU session (e.g., allocated resources, policy rules, etc.). To this end, the SMF 137 may be configured for static PFDs or may query the NEF 141 for dynamic PFDs associated with the PDU session. A PFD may define the sequence of events and steps involved in processing and routing packet flows of the PDU session from the user endpoint device 104 to the appropriate destinations(s) (e.g., within the service network 140, the IMS network 150, or other networks 180). For instance, the PDF may define each network element or hop along the route from the user endpoint device 104 to the appropriate destination(s) as well as any processing performed on the packet flows at each hop, such as filtering, classification, application of QoS policies, and the like, and modifications made to packet headers of the packet flows at each hop.

The UPF 139 may handle data traffic associated with the PDU session and route the data traffic to the appropriate destinations(s) (e.g., within the service network 140, the IMS network 150, or other networks 180). Once the SMF 137 receives the policies and charging counters from the PCF/PCRF 195, the SMF 137 may forward the application detection rules (which have been mapped to the DNN policies via the charging counters) to the UPF 139. Subsequently, once the PDU session has been established and the user endpoint device 104 begins to access applications and services, packet flows to and from the user endpoint device 104 will traverse the UPF 139. The UPF 139 may apply the application detection rules in order to determine how to route these packet flows. For instance, based on the application detection rules, the UPF 139 may determine that a particular packet flow associated with a particular application should be routed to the packet flow's destination, blocked, or redirected.

For instance, referring back to the example in which the PCC APP IDs of the DNN definition 200 that match the rating group IDs of “1000” (e.g., always allowed application) and “2001” (SUB1 application) have been received by the SMF 137 and forwarded to the UPF 139, the UPF 139 would allow (based on the example DNN definition 200 of FIG. 2) any packets of the packet flow containing stream IDs of 50, 55, 60, and catch-all 80.

Thus, when the UPF 139 detects that a packet flow is associated with a particular application or service, and the particular application or service is an application or service to which the subscriber is currently subscribed, then the UPF 139 may route the packet flow to the intended destination. When the UPF 139 detects that a packet flow is associated with a particular application or service, and the particular application or service is an application or service to which the subscriber is not currently subscribed, then the UPF 139 may block the packet flow from reaching the intended destination and/or redirect the PDU session to a portal or landing page via which the subscriber may be offered the opportunity to subscribe to the particular application or service, or to a subscription tier of the particular application or service.

The UPF 139 may also utilize the application detection rules in order to track the subscriber's usage of different applications and services during the PDU session. For instance, periodically during the PDU session (and upon termination of the PDU session), the UPF 139 may generate a report that specifies how much (e.g., how bytes of data) of the PDU session was associated with each of the different applications and services. The report may specify usage by rating groups or service identifiers associated with the different applications and services. The UPF 139 may provide this report to the SMF 137, which may in turn forward the report to the CHF 143. The CHF 143 may forward the report to external processing systems for rating, subscriber billing, further reporting, and other processing.

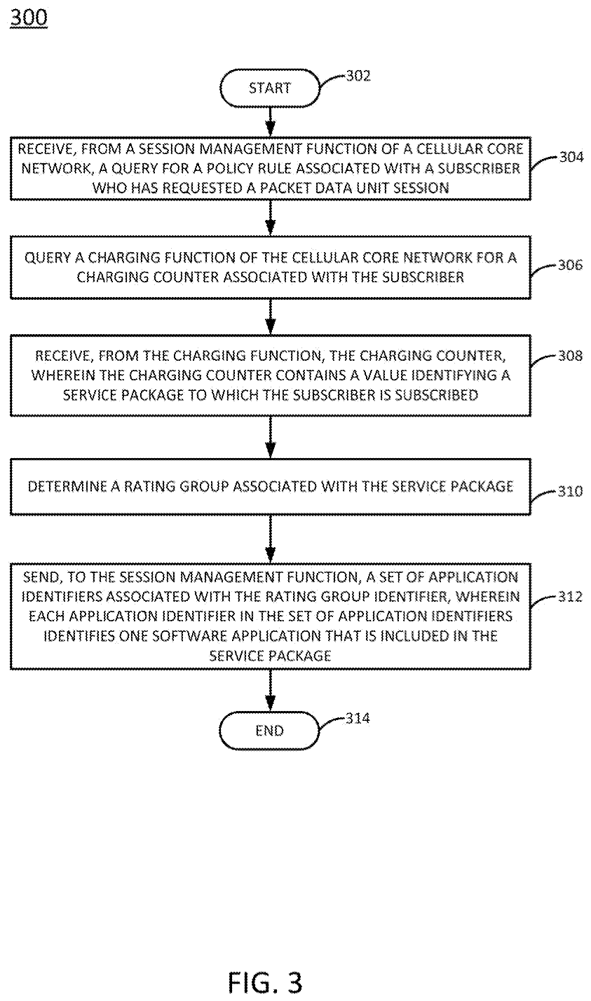

It should be noted that examples of the present disclosure as described herein primarily in connection with steps, functions, and/or operations that are performed by a policy control function for a cellular core network. For instance, FIG. 3 illustrates a flowchart of an example method that may be performed by a PCF (or any one or more components thereof). However, in other, further, and different examples, various steps, functions, and/or operations as described in connection with FIG. 3, or as described elsewhere herein, may alternatively or additionally be performed by one or more other components. For instance, various steps, functions, and/or operations may alternatively or additionally be performed in whole or in part by another processing system in cellular core network 130, such as a CHF 143, a UPF 139, or the like.

The foregoing description of the system 100 is provided as an illustrative example only. In other words, the example of system 100 is merely illustrative of one network configuration that is suitable for implementing examples of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs). In one example, any one or more of the cell sites 121-124 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. Thus, these and other modifications are all contemplated within the scope of the present disclosure.

To further aid in understanding the present disclosure, FIG. 3 illustrates a flowchart of an example method 300 for dynamic traffic classification and handling using charging counters, in accordance with the present disclosure. In one example, the method 300 may be performed by a policy control function of a cellular core network, such as the PCF/PCRF 195 illustrated in FIG. 1. However, in other examples, the method 300 may be performed by another device, such as the processor 502 of the system 500 illustrated in FIG. 5. For the sake of example, the method 300 is described as being performed by a processing system.

The method 300 begins in step 302. In step 304, the processing system may receive, from a session management function of a cellular core network, a query for a policy rule associated with a subscriber who has requested a packet data unit session.

For instance, as discussed above, the subscriber may use a user endpoint device to attempt to connect to the cellular core network via a PDU. Once the subscriber has been verified as a customer of the cellular core network (or a customer of a service provider with whom the operator of the cellular core network has an agreement), the SMF of the cellular core network may begin to establish the PDU session. As part of the process of establishing the PDU session, the SMF may query a policy control function (of which the processing system may be a part) for policy rules defining how the subscriber's data is to be treated during the PDU.

In step 306, the processing system may query a charging function of the cellular core network for a charging counter associated with the subscriber. In one example, upon receiving the request for the policy rule, the processing system may query the CHF for the charging counter. In one example, the charging counter may comprise a DAI. In another example, where the cellular core network comprises an LTE standalone core network, the charging counter may comprise a data session speed tier indicator (DSSTI), where the DSSTI is applied to the APNs via the policy and charging rules function to PGW in a 3G and/or 4G cellular core network.

In step 308, the processing system may receive, from the charging function, the charging counter, wherein the charging counter contains a value identifying a service package to which the subscriber is subscribed. For instance, as discussed above, the charging counter may comprise a DAI. The value in the DAI may comprise an identifier of a service package, such as “SUB1,” “SUB2,” or the like. Alternatively, the value may comprise “ALLOW,” “DENY,” or “REDIRECT,” as discussed above, if the subscriber is not subscribed to any specific service package.

In step 310, the processing system may determine a rating group associated with the service package. For instance, in one example, each possible service package identifier may be associated with at least one rating group of a plurality of rating groups. A first possible rating group may identify applications that a subscriber is always allowed to access, regardless of the service package to which the subscriber may be subscribed (e.g., a rating group of “1000”). Other possible rating groups may identify applications associated with specific service packages (i.e., where only subscribers who are subscribed to those specific service packages may access those applications). Each rating group may be associated with a unique rating group identifier. For instance, a rating group identifier of “2001” may correspond to a service package identifier of “SUB1,” while a rating group identifier of “200n” may correspond to a service package identifier of “SUBn.” Thus, the processing system may identify one or more rating groups associated with the service package.

In step 312, the processing system may send, to the session management function, a set of application identifiers associated with the rating group, wherein each application identifier of the set of application identifiers identifies one software application that is included in the service package. In one example, the mapping of the DNN definition may include a list of application identifiers corresponding to various software applications that are accessible via the cellular core network. These applications may include, for example, streaming music applications, streaming video applications, navigation applications, roadside assistance applications, and the like. Each application identifier may be mapped to a rating group identifier associated with a rating group. Thus, the processing system may utilize the rating group identifier(s) of the rating group(s) determined in step 310 as an index into the mapping. For instance, in FIG. 2, a rating group identifier of 2001 (for service package “SUB1”) would be mapped to applications with application identifiers of APP_2, APP_3, and APP_8. In addition, any application identifiers that are mapped to rating group identifiers that are always allowed (e.g., rating group identifier 1000) may also be identified. In FIG. 2, these application identifiers include APP_1.

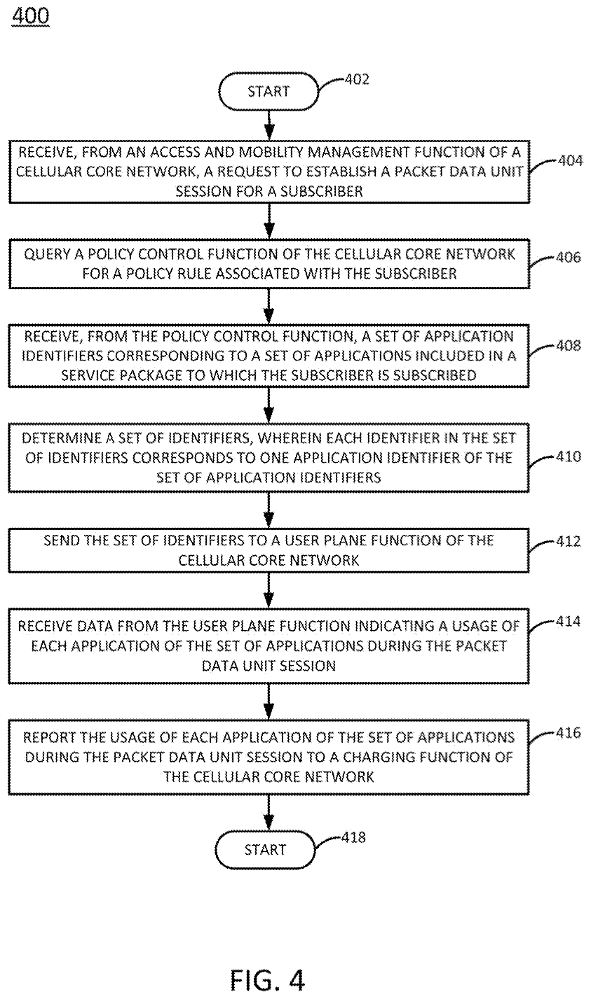

The processing system may send these application identifiers to the SMF. As described above (and further in connection with FIG. 4, below), the SMF may utilize these application identifiers in order to provide information to a UPF of the cellular core network that allows the UPF to track data usage during the PDU session on a per-application basis. By tracking this usage, the subscriber may be billed appropriately for their usage of applications via the cellular core network. The method 300 may end on step 314.

FIG. 4 illustrates a flowchart of an example method 400 for dynamic traffic classification and handling using charging counters, in accordance with the present disclosure. In one example, the method 400 may be performed by a session management function of a cellular core network, such as the SMF 137 illustrated in FIG. 1. However, in other examples, the method 400 may be performed by another device, such as the processor 502 of the system 500 illustrated in FIG. 5. For the sake of example, the method 400 is described as being performed by a processing system.

The method 400 begins in step 402. In step 404, the processing system may receive, from an access and mobility management function of a cellular core network, a request to establish a packet data unit session for a subscriber. For instance, as discussed above, the processing may be part of a SMF of the cellular core network. As part of the process of establishing a PDU session for the subscriber, an AMF of the cellular core network may, upon verifying that the subscriber is an authorized user of the cellular core network, forward the subscriber's request for the PDU session to the SMF.

In step 406, the processing system may query a policy control function of the cellular core network for a policy rule associated with the subscriber. For instance, as discussed above, as part of establishing the PDU session, the SMF may query a policy control function (of which the processing system may be a part) for policy rules defining how the subscriber's data is to be treated during the PDU.

In step 408, the processing system may receive, from the policy control function, a set of application identifiers corresponding to a set of applications included in a service package to which the subscriber is subscribed. As discussed above, the PCF may communicate with a CHF of the cellular core network in order to obtain charging counters that identify a service package to which the subscriber is subscribed. The service package may define a set of applications that the subscriber is authorized to access via the cellular core network, such as streaming music applications, streaming video applications, navigation applications, roadside assistance applications, and the like. The PCF may map the charging counters to a set of application identifiers in a DNN definition for the PDU session. Each application identifier in the set of application identifiers may correspond to one application that is included in the service package to which the subscriber is subscribed.

In step 410, the processing system may determine a set of identifiers, wherein each identifier in the set of identifiers corresponds to one application identifier of the set of application identifiers. In one example, the processing system may map each application identifier of the set of application identifiers to a static identifier. In one example, the static identifier may comprise a service identifier. The service identifier may comprise a numerical identifier that is mapped, in the DNN definition for the PDU session, to an application identifier, as shown in FIG. 2. Thus, in one example, the set of identifiers may comprise a set of service identifiers.

In another example, the processing system may query a NEF of the cellular core network for packet flow descriptors that match the application identifiers. Thus, in another example, the set of identifiers may comprise a set of PFDs.

In step 412, the processing system may send the set of identifiers to a user plane function of the cellular core network. For instance, the processing system may send a set of service identifiers or a set of PFDs to the UPF. The UPF may, as discussed above, utilize the set of identifiers to track application usage by a user endpoint device of the subscriber during the PDU session.

In step 414, the processing system may receive data from the user plane function indicating a usage of each application of the set of applications during the packet data unit session. For instance, as discussed above, using the set of identifiers, the UPF may be able to determine that the user endpoint device of the subscriber utilized x megabytes of data in connection with a first application y megabytes of data in connection with a second application, and the like.

In one example, the processing system may receive the data from the UPF on a periodic basis. Thus, step 414 may occasionally repeat until the PDU session is terminated. Upon termination of the PDU session, the processing system may receive a final set of data from the UPF.

In step 416, the processing system may report the usage of each application of the set of applications during the packet data unit session to a charging function of the cellular core network. In one example, the processing system may report, for each combination of rating group identifier and service identifier, an amount of data (e.g., in megabytes) that was used by the user endpoint device of the subscriber during the PDU. Since each combination of service identifier and rating group identifier is unique to a particular application, the CHF may be able to determine how much data was used in connection with each application during the PDU session. The CHF may report this usage to an operator of the cellular core network and/or to service providers who support the applications, who may utilize the usage information to bill the subscriber appropriately for the usage.

In one example, the processing system may report to the CHF each time data is received from the UPF. Thus, step 416 may occasionally repeat until the PDU session is terminated. Upon termination of the PDU session, the processing system may report final usage data to the CHF. The method 400 may end in step 418.

Although not expressly specified above, one or more steps of the method 300 or the method 400 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 3 of FIG. 4 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

Thus, examples of the present disclosure allow appropriate action to be taken in response to wireless data usage based on a charging profile for a user endpoint device. Additionally, applications and services can be grouped together and offered to subscribers as packages associated with different charging values, and the network can efficiently allow and rate data usage by user endpoint devices, drop usage by the user endpoint devices, or redirect the user endpoint devices. Applications and services can be grouped together and associated with a rating group that supports different policy decisions with the network. This reduces the time to market for packages of diverse applications and services.

FIG. 5 depicts a high-level block diagram of a computing device specifically programmed to perform the functions described herein. For example, any one or more components or devices illustrated in FIG. 1 or described in connection with the method 300 or method 400 may be implemented as the system 500. For instance, a PCF (such as might be used to perform the method 300) or an SMF (such as might be used to perform the method 400) could be implemented as illustrated in FIG. 5.

As depicted in FIG. 5, the system 500 comprises a hardware processor element 502, a memory 504, a module 505 for dynamic traffic classification and handling using charging counters, and various input/output (I/O) devices 506.

The hardware processor 502 may comprise, for example, a microprocessor, a central processing unit (CPU), or the like. The memory 504 may comprise, for example, random access memory (RAM), read only memory (ROM), a disk drive, an optical drive, a magnetic drive, and/or a Universal Serial Bus (USB) drive. The module 505 for dynamic traffic classification and handling using charging counters may include circuitry and/or logic for identifying and tracking usage of applications included in a service package. The input/output devices 506 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 505 for dynamic traffic classification and handling using charging counters (e.g., a software program comprising computer-executable instructions) can be loaded into memory 504 and executed by hardware processor element 502 to implement the steps, functions or operations as discussed above in connection with the example method 300 or example method 400. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for dynamic traffic classification and handling using charging counters (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described examples, but should be defined only in accordance with the following claims and their equivalents.

What is claimed is:

1. A method comprising:
receiving, by a processing system in a cellular core network including at least one processor and from a session management function of the cellular core network, a query for a policy rule associated with a subscriber who has requested a packet data unit session;
querying, by the processing system, a charging function of the cellular core network for a charging counter associated with the subscriber;
receiving, by the processing system and from the charging function, the charging counter, wherein the charging counter contains a value identifying a service package to which the subscriber is subscribed;
determining, by the processing system, a rating group associated with the service package; and
sending, by the processing system to the session management function, a set of application identifiers associated with the rating group, wherein each application identifier of the set of application identifiers identifies one software application that is included in the service package.

2. The method of claim 1, wherein the processing system is part of a policy control function of the cellular core network.

3. The method of claim 1, wherein the charging function comprises a data access indicator.

4. The method of claim 3, wherein the value identifying the service package to which the subscriber is subscribed is contained in the data access indicator.

5. The method of claim 4, wherein the data access indicator is defined by an operator of the cellular core network.

6. The method of claim 4, wherein the service package corresponds to a set of applications, including the one software application, to which the subscriber is permitted access via the cellular core network.

7. The method of claim 1, wherein each application identifier of the set of application identifiers is mapped to a rating group identifier of the rating group in a data network name definition.

8. The method of claim 7, wherein the data network name definition further maps each application identifier of the set of application identifiers to a packet flow descriptor.

9. The method of claim 8, wherein the data network name definition further maps each application identifier of the set of application identifiers to a service identifier.

10. The method of claim 9, wherein each application identifier of the set of application identifiers is associated with a unique combination of rating group identifier and service identifier.

11. The method of claim 1, wherein the processing system further sends to the session management function a set of application identifiers associated with another rating group that corresponds to a set of applications that the subscriber is always allowed to access, regardless of the service package.

12. The method of claim 1, wherein the session management function determines a set of identifiers, wherein each identifier in the set of identifiers corresponds to one application identifier of the set of application identifiers.

13. The method of claim 12, wherein the set of identifiers comprises a set of service identifiers that are mapped to the set of application identifiers in a data network name definition.

14. The method of claim 13, wherein the session management function sends the set of service identifiers to a user plane function of the cellular core network for use in monitoring usage of a set of applications identified by the set of application identifiers during the packet data unit session.

15. The method of claim 14, wherein the usage of the set of applications identified by the set of application identifiers during the packet data unit session is periodically reported by the user plane function to the session management function.

16. The method of claim 12, wherein the set of identifiers comprises a set of packet flow descriptors that are mapped to the set of application identifiers in a data network name definition.

17. The method of claim 16, wherein the session management function sends the set of packet flow descriptors to a user plane function of the cellular core network for use in monitoring usage of a set of applications identified by the set of application identifiers during the packet data unit session.

18. The method of claim 17, wherein the set of packet flow descriptors is one of: statically configured or retrieved from a network exposure function of the cellular core network.

19. A non-transitory computer-readable medium storing instructions which, when executed by a processing system in a cellular core network including at least one processor, cause the processing system to perform operations, the operations comprising:
receiving, from a session management function of the cellular core network, a query for a policy rule associated with a subscriber who has requested a packet data unit session;
querying a charging function of the cellular core network for a charging counter associated with the subscriber;
receiving, from the charging function, the charging counter, wherein the charging counter contains a value identifying a service package to which the subscriber is subscribed;
determining a rating group associated with the service package; and
sending, to the session management function, a set of application identifiers associated with the rating group, wherein each application identifier of the set of application identifiers identifies one software application that is included in the service package.

20. A device comprising:
a processing system in a cellular core network including at least one processor; and
a computer-readable medium storing instructions which, when executed by the processing system, cause the processing system to perform operations, the operations comprising:
receiving, from a session management function of the cellular core network, a query for a policy rule associated with a subscriber who has requested a packet data unit session;
querying a charging function of the cellular core network for a charging counter associated with the subscriber;
receiving, from the charging function, the charging counter, wherein the charging counter contains a value identifying a service package to which the subscriber is subscribed;
determining a rating group associated with the service package; and
sending, to the session management function, a set of application identifiers associated with the rating group, wherein each application identifier of the set of application identifiers identifies one software application that is included in the service package.
